(19) United States
(12) Patent Application Publication
(10) Pub. No.: US 2008/0158648 A1
(43) Pub. Date: Jul. 3, 2008

(54) Peripheral switches for MEMS display test

(76) Inventor: William J. Cummings, Millbrae, CA (US)

Correspondence Address: KNOBBE, MARTENS, OLSON & BEAR, LLP, 2040 MAIN STREET, FOURTEENTH FLOOR, IRVINE, CA, 92614, US

(21) Appl. No.: 11/648,244

(22) Filed: Dec. 29, 2006

(51) Int. Cl. G02B 26/00

(52) U.S. Cl. 359/291

(57) ABSTRACT

A MEMS (Microelectromechanical system) device is described. The device includes an array of MEMS elements with addressing lines, one or more connection pads, and switches configured to selectively connect two or more of the addressing lines to the connection pads. The arrangement is particularly advantageous for testing the array, because test signals may be applied to the connection pads and selectively applied to separate groups of one or more MEMS elements.

### BACKGROUND

1. Field of the Invention

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

2. Description of the Related Technology

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY OF CERTAIN EMBODIMENTS

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

One embodiment is a MEMS (Microelectromechanical system) device including an array of MEMS elements, the array including a plurality of addressing lines. The device also includes at least one connection pad, and a plurality of switches configured to selectively connect one or more of the addressing lines to the at least one connection pad.

Another embodiment is a method of testing a MEMS (Microelectromechanical system) device including an array of MEMS elements, where the array includes a plurality of addressing lines, a connection pad, and a plurality of switches configured to selectively connect the plurality of addressing lines to the connection pad. The method includes providing an electrical signal to the switches so as to configure the switches to electrically connect the plurality of addressing lines to the connection pad, and providing an electrical signal to the connection pad so as to actuate one or more of the MEMS elements.

Another embodiment is a method of operating a MEMS (Microelectromechanical system) device including an array of MEMS elements, where the array includes a plurality of addressing lines, a connection pad, and a plurality of switches configured to selectively connect the plurality of addressing lines to the connection pad. The method includes providing an electrical signal to the switches so as to configure the switches to electrically disconnect the plurality of addressing lines from the connection pad, and providing one or more electrical signals to the plurality of addressing lines so as to operate the MEMS elements.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a schematic diagram showing an embodiment of an interferometric modulator array with test signal connection pads.

FIG. 9 is a schematic diagram showing an embodiment of an interferometric modulator array with peripheral switches to selectively connect the array and test connection pads.

FIGS. 10A and 10B are cross-sectional and top views of a MEMS switch, respectively.

FIG. 11 is a cross-sectional view of another MEMS switch embodiment.

FIG. 12 is a schematic diagram showing an embodiment of an interferometric modulator array with peripheral MEMS switches to selectively connect the array and test connection pads.

### DETAILED DESCRIPTION OF CERTAIN EMBODIMENTS

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Interferometric modulators described below sometimes suffer manufacturing yield loss because of large electric fields which occur during removal of a sacrificial layer during fabrication. Embodiments discussed below include switches which temporarily electrically short sensitive layers so as to prevent the electric fields from developing. The switches are configured to short the sensitive layers during the fabrication steps during which the damaging electric fields develop, and to remain open thereafter. Similarly, testing of an array of interferometric modulators with many row lines and column lines requires many input signals. Embodiments discussed below include switches which temporarily electrically short subsets of rows and/or columns so that fewer input signals may be used. The switches are configured to short the subsets during the testing operation, and to remain open thereafter.

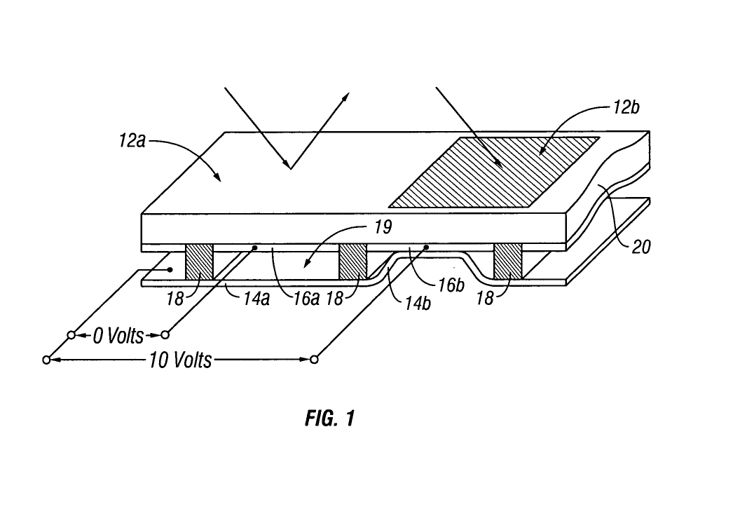

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise of several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the cavity 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

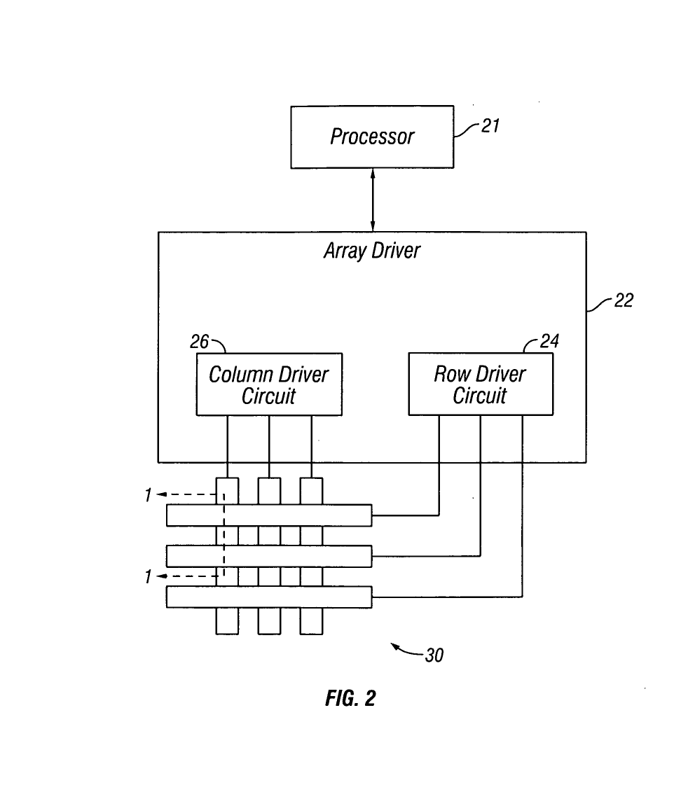

FIGS. 2 through 5B illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

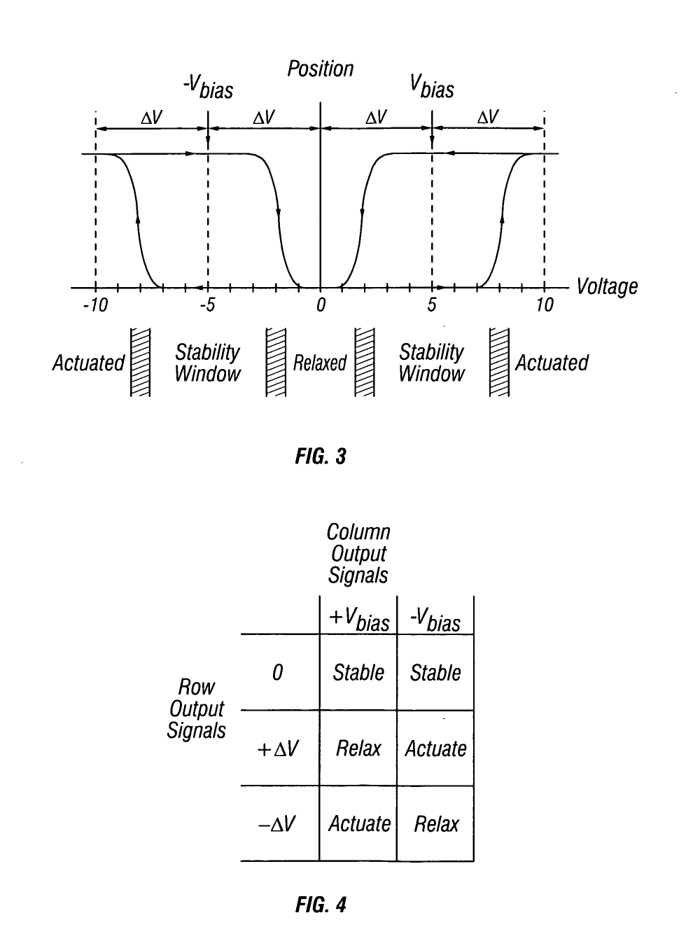

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

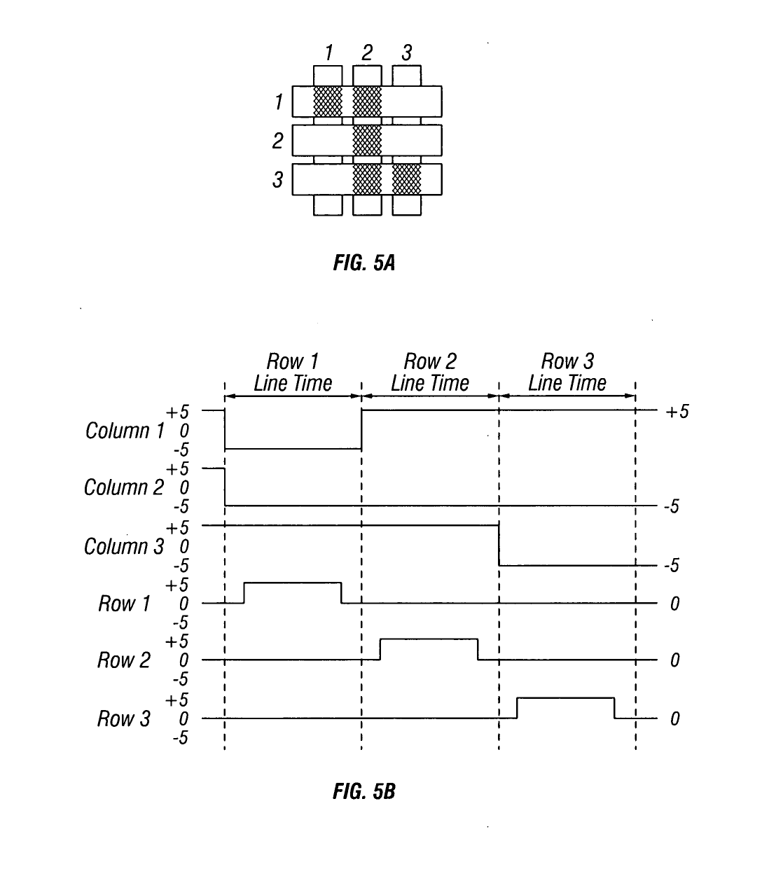

FIGS. 4, 5A, and 5B illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

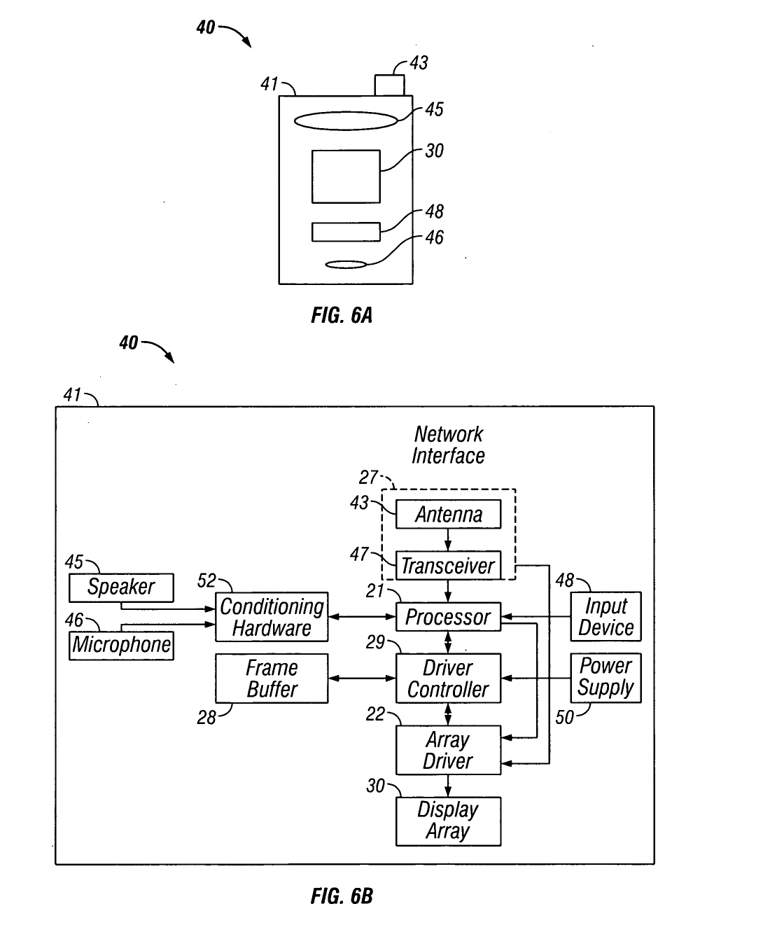

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 44, an input device 48, and a microphone 46. The housing 41 is generally formed from any of a variety of manufacturing processes as are well known to those of skill in the art, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11 (a), (b), or (g). In another embodiment, the antenna transmits and receives RF signals according to the BLUETOOTH standard. In the case of a cellular telephone, the antenna is designed to receive CDMA, GSM, AMPS or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. Those of skill in the art will recognize that the above-described optimization may be implemented in any number of hardware and/or software components and in various configurations.

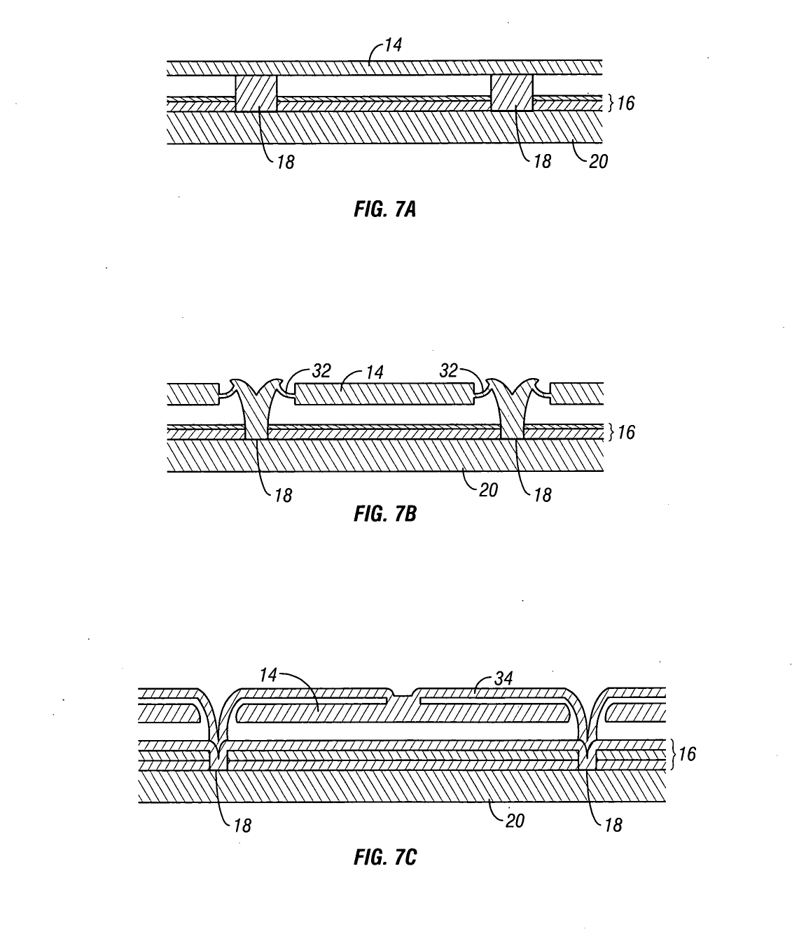

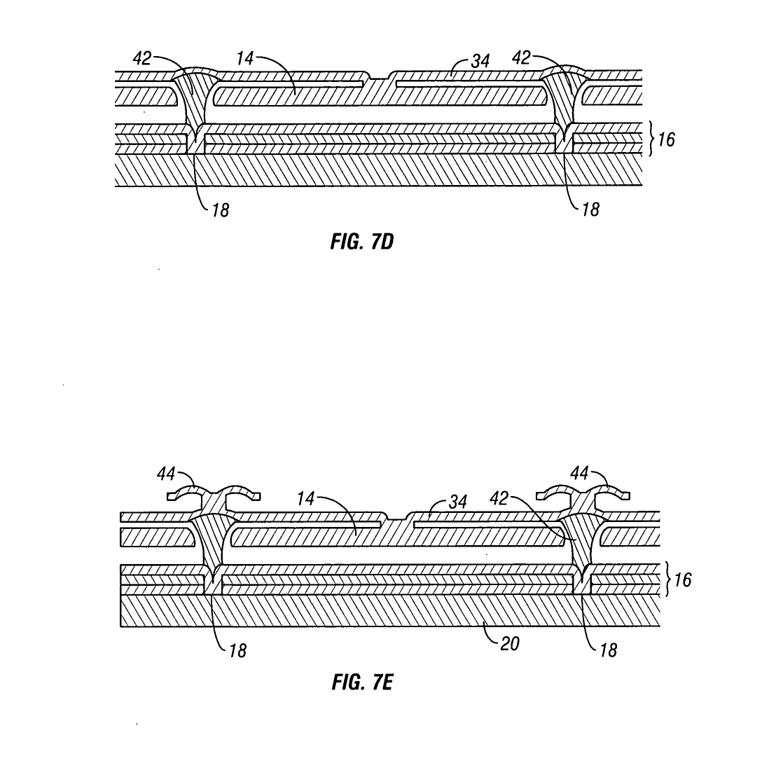

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the cavity, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

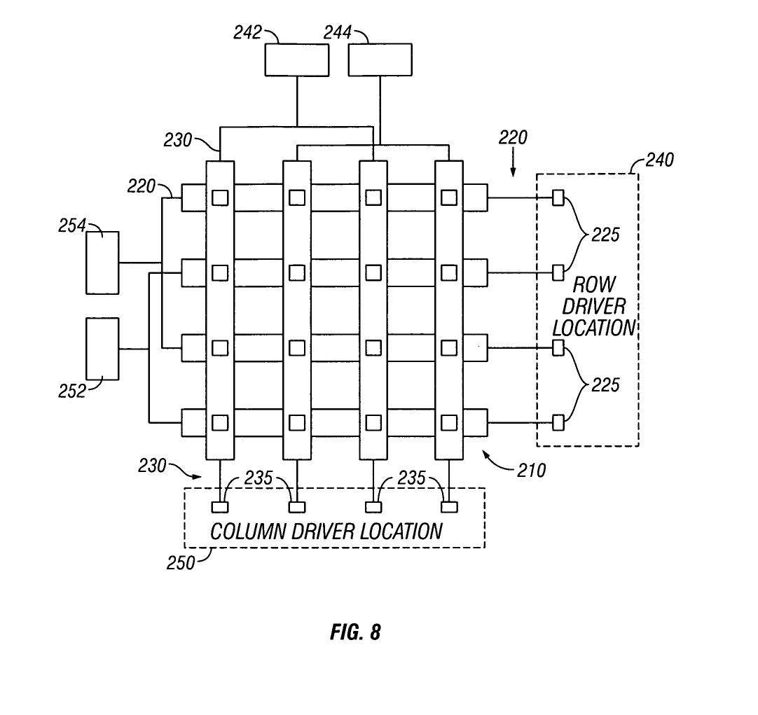

Many such interferometric modulators are fabricated in an array on a substrate. Addressing lines from individual array rows and columns to a substrate location intended for row and column drivers, respectively, are also placed on the substrate. This allows each row and each column to be individually driven by the corresponding addressing lines during operation. FIG. 8 is a schematic view showing an array 210 with row addressing lines 220 connected to row driver bond pads 225 and extending from the rows of array 210 to a row driver location 240 and column addressing lines 230 connected to column driver bond pads 235 and extending from the columns of array 210 to a column driver location 250. Once row and column drivers are placed on the substrate the array can be exercised according to signals from the drivers.

Although shown in FIG. 8 schematically as two separate blocks, in some embodiments, column and row drivers are physically within a single integrated circuit, which may be soldered to the row driver bond pads 225 and column driver bond pads 235. Accordingly, a physical representation of such embodiments would show row driver location 250 and column driver location 240 as continuous. Generally, there is at least one area (shown as 240 and/or 250 in FIG. 8) on the substrate that is configured for driver chip placement by its location relative to signal line connections that couple the driver circuitry to the array rows and columns.

It is desirable to verify the functionality of the array 210 before placing the drivers. FIG. 8 shows that certain column addressing lines are connected to connection pad 242, certain other column addressing lines are connected to connection pad 244, certain row addressing lines are connected to connection pad 254, and certain other row addressing lines are connected to connection pad 252. Connection pads 242, 244, 252, and 254 can be used to apply input signals to the rows and columns of the array 210 with a test fixture. Accordingly, the functionality of the array elements may be tested before installing driver circuits.

In some embodiments, connection pads 242, 244, 252, and 254 may be bond pads, probe pads or any other type of electrical connection to external circuits. In some embodiments, at least some connection pads are probe pads, which allow for convenient testing using, for example, a probe station. Because each connection pad 242, 244, 252, and 254 is connected to multiple rows or columns, the number of test signals needed to exercise the array 210 is much less than the number of rows and columns. In the embodiment show in FIG. 8, four connection pads are used to drive the 4×4 array 210. However, using a similar alternating row and alternating column connection arrangement, four connection pads can be used to drive an array of essentially any size.

With signals of opposite polarities applied to alternate rows and columns, a checkerboard pattern is driven to the array. If alternating input signals of opposite polarity are applied to connection pads 242 and 244 or to connection pads 252 and 254, the checkerboard pattern will invert once for each cycle of the alternating input signals. Checkerboard patterns and inverting checkerboard patterns can be effective in finding defects in manufactured MEMS arrays. Vertical or horizontal line patterns are another effective pattern for finding defects. Vertical line patterns can be generated by applying signals of opposite polarity to column connection pads 242 and 244 and applying signals of identical polarity to row connection pads 252 and 254. An inverting pattern of vertical lines can be generated by either reversing the polarity of the signals of the column connection pads 242 and 244 or by reversing the polarity of the signals of the row connection pads 252 and 254. Similarly, horizontal line patterns can be generated by applying signals of opposite polarity to row connection pads 252 and 254 and applying signals of identical polarity to column connection pads 242 and 244. An inverting pattern of horizontal lines can be generated by either reversing the polarity of the signals of the column connection pads 242 and 244 or by reversing the polarity of the signals of the row connection pads 252 and 254.

While useful for delivering certain test signal patterns to the array during test operations, because the connection pads short multiple rows and columns together, the connection pads are undesirable for normal operation, where each row and column is driven independently by row and column drivers. Accordingly, the connections between the connection pads and the array are severed after verifying that the array is functional and before installing the row and column drivers. Once the connections are severed, the row and column drivers may drive the rows and columns of the array independently.

The severing operation may, for example, comprise etching the connections or cutting away the portion of the substrate with the connections. The additional processing time required to performing a severing operation adds additional delays to production. In addition, the severing operation adds complication and cost to the manufacturing process.

In advantageous embodiments, connectivity is provided by one or more electrically controllable switches, rather than with hard wired connections. The conditional connectivity of the electrically controllable switches can be managed through electrical signals rather than through additional processing, as is necessary when using prior art connection schemes.

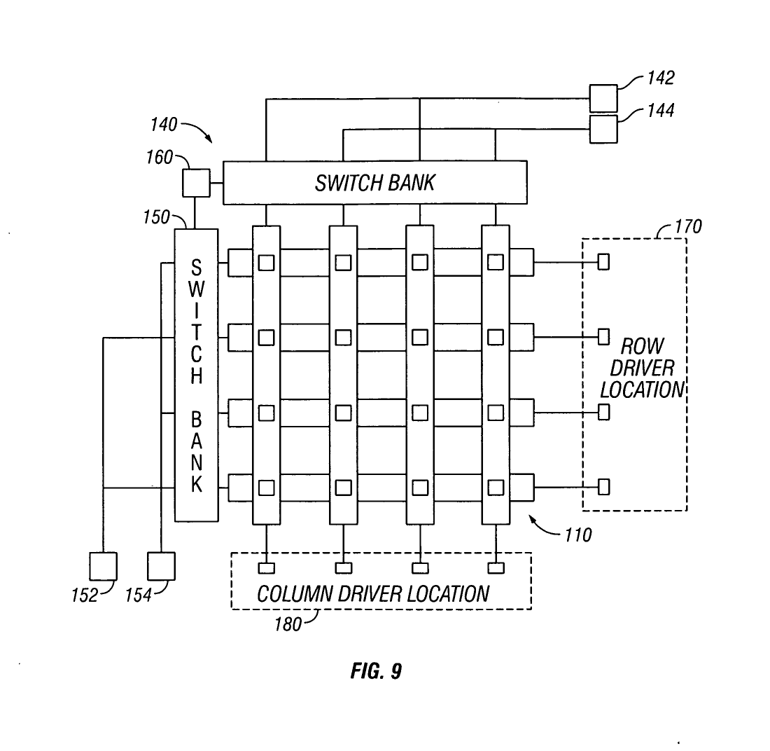

FIG. 9 shows an array of MEMS devices 110, switch bank 140, switch bank 150, column connection pads 142 and 144, row connection pads 152 and 154, control connection pad 160, row driver location 170, and column driver location 180. This configuration eliminates the need for the severing operation.

Switch bank 140 connects columns of array 110 to column connection pads 142 and 144. Similarly, switch bank 150 connects rows of array 110 to row connection pads 152 and 154. The switches may be transistors, MEMS switches or other types of switching devices. The switches may also be a combination of one or more switch types. While the embodiment of FIG. 9 shows a particular configuration of switches, other arrangements may be used. For example, in the embodiment shown in FIG. 9, every other row is connected to a common row connection pad, and every other column is connected to a common column connection pad. Other embodiments, may however, group rows and columns differently. In some embodiments more connection pads are used, and every third or fourth row or column is connected to a common connection pad. In some embodiments, groups of two or more adjacent rows or columns are connected to a common connection pad, for example, in a repeating ABBA pattern. In some embodiments, each of the columns is connected to a separate connection pad. Similarly, in some embodiments, each of the rows is connected to a separate connection pad.

The switches of switch banks 140 and 150 are configured such that one or more control signals alter the functionality of the switches. For example, during test operation, a test mode signal from connection pad 160 can be used to selectively connect the array 110 to the connection pads 142, 144, 152 and 154. Connection pad 160 may, for example, be connected to the gates of each of a set of transistors forming switch banks 140 and 150. Also, during regular operation, when the connection pads 142, 144, 152, and 154 are not used to drive the array 110, the test mode signal from connection pad 160 can be used to disconnect the array 110 from the connection pads 142, 144, 152 and 154. Accordingly, because switch banks 140 and 150 are used to selectively connect the rows and columns of array 110 to the connection pads 142, 144, 152 and 154, the connections between the array and the connection pads 142, 144, 152 and 154 do not need to be severed in a separate manufacturing step for normal operation.

In some embodiments, the switch banks 140 and 150 and/or connection pads 142, 144, 152, and 154 are physically located at least partly in either or both of the row and column driver locations 170 and 180. In these embodiments, the connection pads 142, 144, 152, and 154, and switch banks 140 and 150 do not require their own dedicated substrate area.

While FIG. 9 shows a single control connection pad 160 connected to switch banks 140 and 150, other embodiments have multiple connection pads connected so as to separately control subsets of switches of switch banks 140 and 150. For example, in some embodiments, one control connection pad is connected to the switches of switch bank 140 and a second control connection pad is connected to the switches of switch bank 150. In other embodiments, one or more sets of rows are connected to switches with connections to separate control connection pads. Similarly, in some embodiments, one or more sets of columns are connected to switches operated by separate control connection pads.

The connection arrangement between the array and the connection pads is not limited to that shown in the embodiment of FIG. 9. Using multiple switches and multiple control, row, and column connection pads, one skilled in the art will clearly recognize that numerous connection arrangements of various complexity and functionality may be implemented.

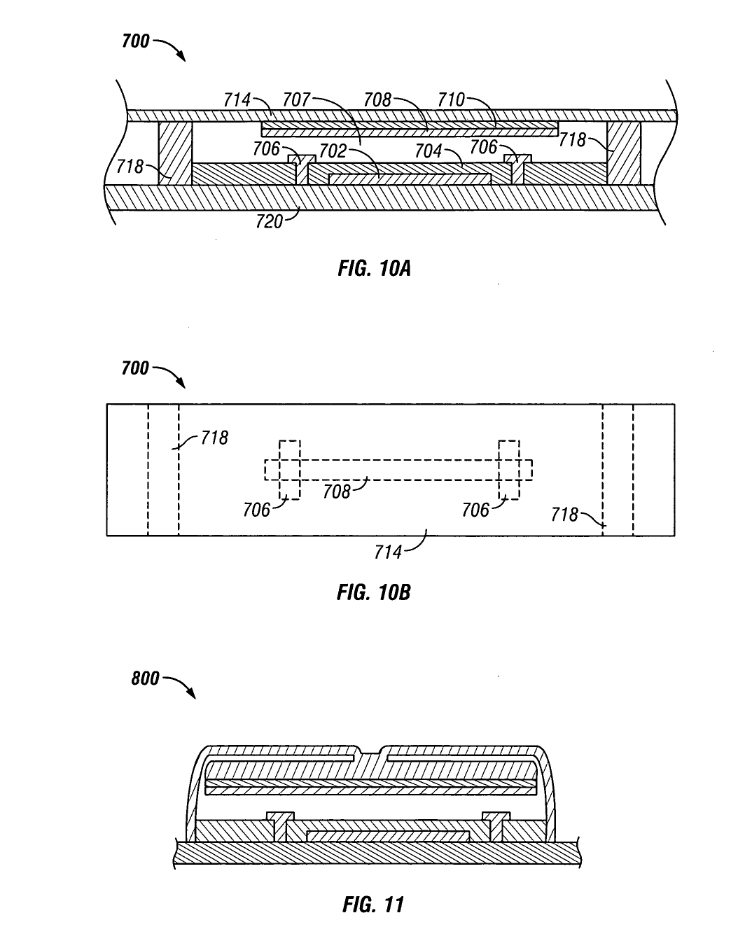

With some modifications, the basic structure of an interferometric modulator can be used as a MEMS switch to perform the switching functions described above. FIG. 10A is a cross-sectional side view of a MEMS switch 700. The MEMS switch 700 of FIG. 10A has similar collapsible cavity features as the interferometric modulator of FIG. 7A. The MEMS switch 700 additionally includes two terminals 706, an insulating layer 710, and a conductive strip 708. The MEMS switch 700 is a structure that provides selective electrical contact between the two terminals 706. More particularly, the MEMS switch 700 is considered closed when the terminals 706 are in electrical contact and the MEMS switch is considered open when the terminals 706 are not in electrical contact. In a mechanically relaxed state, terminals 706 are not in electrical contact and, thus, the MEMS switch 700 is open. As shown in FIG. 10A, the MEMS switch 700 comprises a moveable material 714, a conductive strip 708, and an insulating layer 710 between the moveable material 714 and the conductive strip 708. A substrate 720 supports an electrode 702, and an insulating layer 704 on the electrode 702. Two terminals 706, separated by a distance, are deposited on and/or through the insulating layer 704. The terminals 706 may connect to other circuitry using vias through insulating layer 704 and/or electrode 702. Insulating layer 704 and moveable material 714 are mechanically separated by supports 718 in order to define a cavity 707. As described above with respect to interferometric modulators, the moveable material 714 is deformable, such that the moveable material 714 may be deformed towards the substrate 720 when a voltage difference is applied across the moveable material 714 and the electrode 702. This is analogous to the reflective material 14, substrate 20, and electrode 16 of FIG. 7A, and to the reflective layers 14a and 14b, the transparent substrate 20, and the reflective layers 16a and 16b of FIG. 1. The moveable material 714 may have on it an insulator 710, which has upon it the conductive strip 708. The conductive strip 708 is aligned so that when the moveable material 714 is deflected towards the substrate 720 by an applied potential as described above, the conductive strip 708 contacts both of the terminals 706, causing the terminals 706 to be in electrical contact and the MEMS switch 700 to be closed. In this embodiment, the conductive strip 708 is electrically isolated from the moveable material 714 by insulator 710 so that contact between the terminals 706 and the movable material 714 does not disturb the voltage difference applied across the moveable material 714 and the electrode 702. In some embodiments, where such isolation is not necessary, the conductive strip 708 and the insulator 710 will not be needed, and the moveable material itself 714 can function as the conductor that bridges the two terminals 706. When the voltage applied across the moveable material 714 and the electrode 702 is reduced below a certain level (as is also described above), the moveable material 714 returns to its mechanically relaxed state and the MEMS switch 700 is opened.

FIG. 10B is a top view of MEMS switch 700. The supports 718, the conductive strip 708, and the terminals 706 are shown as seen looking through the moveable material 714. Conductive strip 708 may be significantly smaller than the moveable material 714. This is to ensure that the electromotive force between the moveable material 714 and the electrode 702 is larger than the electromotive force between the conductive strip 708 and the electrode 702 because once the strip contacts the electrodes, the potential on the strip may differ from the potential on the moveable material.

FIG. 11 is a cross-sectional side view of a MEMS switch 800 of another embodiment. MEMS switch 800 has similar constructional features as the interferometric modulator of FIG. 7C. It also has MEMS switch functionality and features similar to those of MEMS switch 700 in FIG. 8A.

MEMS switches built from the same basic structure as interferometric modulators ease the integration of logic and switching functions with interferometric modulator arrays. It is possible that the other types of switches may be integrated, such as switches fabricated in a manner not similar to the fabrication of the interferometric elements, and more conventional electronic switches fabricated using thin silicon films deposited on the glass substrate. However, because fabrication of interferometric modulator based MEMS switches may be performed using many of the same processing steps that are used in fabricating interferometric modulators, these MEMS switches may be inexpensively integrated onto the same substrate as an array of interferometric modulators used, for example, for a display.

For example, in one embodiment the MEMS switches and interferometric modulators may be fabricated using the same process, although extra steps may be performed on the interferometric modulators and/or the MEMS switches during the manufacturing process. For example, deposition and etching steps to add terminals to the MEMS switches are unnecessary for the fabrication of interferometric modulators. In such an embodiment some common steps would be performed, such as those for forming the electrodes, etc. The MEMS switch terminals would then be formed. After these steps would follow more steps necessary for both the interferometric modulators and the MEMS switches, thus providing a combined interferometric modulator and MEMS switch array. In yet another embodiment, the same process that is used for manufacturing interferometric modulators is used in manufacturing MEMS switches. The interferometric modulators may first be fabricated on a substrate, followed by fabrication of MEMS switches on the substrate. Similarly, MEMS switches may first be fabricated on a substrate, followed by fabrication of interferometric modulators on the substrate. In either case, the manufacturing process does not require significant modification as the MEMS switches comprise many of the same structures as the interferometric modulators.

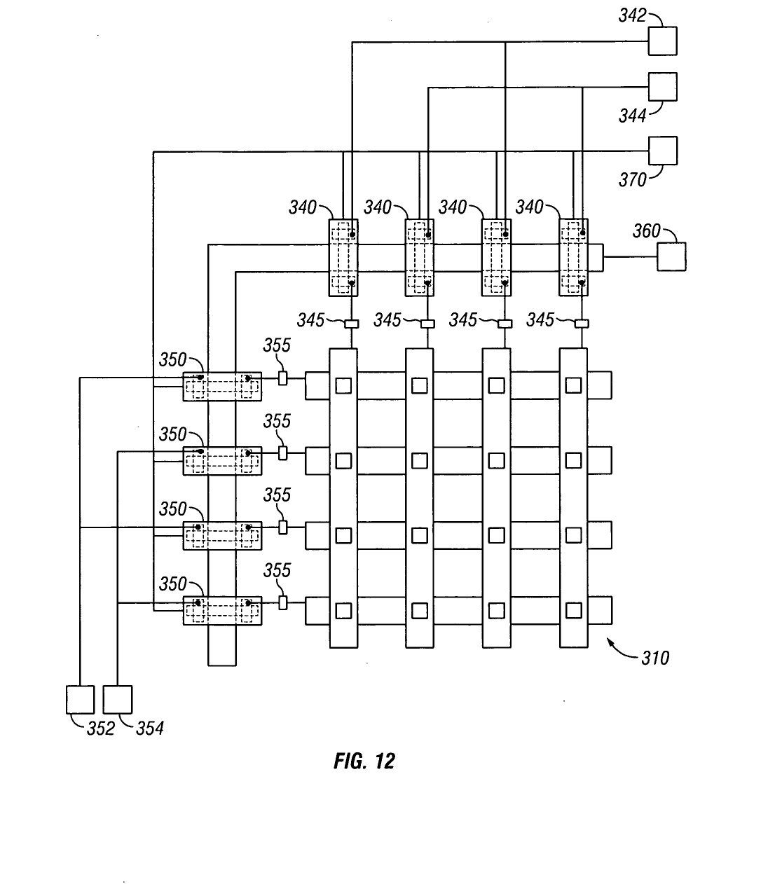

FIG. 12 is a schematic view showing an embodiment with MEMS column switches 340 and row switches 350 built from the same basic structure as interferometric modulators of the array 310. In this embodiment, the switches each have two terminals and a conductive strip. Accordingly, these switches have a structure similar to the structure of switch 700, shown in FIGS. 10A and 10B. Switches with other structures may also be used. The column switches 340 are configured to selectively connect sets of columns of array 310 to column connection pads 342 and 344. Similarly, the row switches 350 are configured to selectively connect sets of rows of array 310 to row connection pads 352 and 354. In the embodiment shown, one terminal of each switch 340 and 350 is connected to one connection pad 342, 344, 352, or 354, and the other terminal of each switch 340 and 350 is connected to either a column or row electrode of the array 310. Accordingly, when a switch is actuated, as described above with reference to FIGS. 10A and 10B, the conductive strip electrically connects the two terminals whereby the associated connection pad is connected to the associated row or column electrode. Control connection pad 360 is configured to connect to the substrate electrode of each of the switches 340 and 350. According to the voltage applied to control connection pad 360, the switches 340 and 350 will selectively connect the rows and columns of array 310 to the connection pads 342, 344, 352, and 354. The embodiment of FIG. 12 shows the ease of integration of the MEMS switches 340 and 350 with the MEMS array 310.

In some embodiments, the bond pads 345 and 355 for driver circuit connection are physically located on the electrical connection between the switch 340 or 350 and the row or column associated with the switch 340 or 350. Such a physical arrangement may allow for a driver chip (not shown) to be placed near the array 310 and over the same physical location of the switch banks. Accordingly, substrate area is used for both the driver chip and switch banks 340 and 350.

Because the actuation of the switches 340 and 350 is determined by a difference between the voltage at the substrate electrode and the deformable layer electrode, the absolute voltage at the deformable layer electrode is arbitrary, and may, therefore, be held at a desired voltage, such as circuit common, via dedicated probe pad 370. In some embodiments, because the absolute voltage at the deformable layer electrode is arbitrary, and because the deformable layers of the switches 340 and 350 are electrically isolated from the terminals of the switches 340 and 350, the deformable layer electrode of the switches 340 and 350 may be connected to one of the row or column connection pads 342, 344, 352, or 354. In such embodiments, a row or a column connection pad is used to additionally drive the deformable layer electrode of the switches 340 and 350. For example, if the deformable layer electrode is connected to connection pad 342, the state of the switches 340 and 350 will correspond to the voltage difference between connection pad 342 and control connection pad 360. The voltage state of connection pad 342 will correspond to the data to be driven to the array columns associated with connection pad 342, and the voltage state of control connection pad 360 will correspond to the desired state of the switches according to the current voltage state of connection pad 342.

While the MEMS devices discussed above are interferometric modulators, other embodiments comprise other MEMS devices.

While the above detailed description has shown, described, and pointed out novel features as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A MEMS (Microelectromechanical system) device comprising:
an array of MEMS elements, the array comprising a plurality of addressing lines;
at least one connection pad; and
a plurality of switches configured to selectively connect one or more of the addressing lines to the at least one connection pad.

2. The device of claim 1, wherein the array comprises an interferometric light modulator.

3. The device of claim 1, wherein the connection pad comprises at least one of a bond pad and a probe pad.

4. The device of claim 1, further comprising a substrate, the substrate comprising an area configured for occupation by a driver circuit, wherein one or more of the plurality of switches are positioned in said area.

5. The device of claim 1, wherein the switches are configured to selectively connect every other row addressing line to the connection pad.

6. The device of claim 1, wherein the switches are configured to selectively connect every other column addressing line to the connection pad.

7. The device of claim 1, comprising two or more connection pads, wherein the plurality of switches is configured to selectively connect each of the addressing lines to one of the two or more connection pads.

8. The device of claim 1, comprising four or more connection pads, and the array comprising:
first and second sets of non-adjacent rows;
first and second sets of non-adjacent columns;
a first group of addressing lines connected to the first set of non-adjacent rows;
a second group of addressing lines connected to the second set of non-adjacent rows;
a third group of addressing lines connected to the first set of non-adjacent columns;
a fourth group of addressing lines connected to the second set of non-adjacent columns,
wherein the plurality of switches is configured to selectively connect each of the first, second, third, and fourth group of addressing lines to one of the four connection pads.

9. The device of claim 1, further comprising:
a display;
a processor configured to communicate with the display, the processor being configured to process image data; and
a memory device that is configured to communicate with said processor.

10. The device of claim 9, further comprising a driver circuit configured to send at least one signal to the display.

11. The device of claim 10, further comprising a controller configured to send at least a portion of the image data to the driver circuit.

12. The device of claim 9, further comprising an image source module configured to send said image data to the processor.

13. The device of claim 12, wherein the image source module comprises at least one of a receiver, transceiver, and transmitter.

14. The device of claim 9, further comprising an input device configured to receive input data and to communicate the input data to the processor.

15. A method of testing a MEMS (Microelectromechanical system) device comprising an array of MEMS elements, wherein the array comprises a plurality of addressing lines, a connection pad, and a plurality of switches configured to selectively connect the plurality of addressing lines to the connection pad, the method comprising:
providing an electrical signal to the switches so as to configure the switches to electrically connect the plurality of addressing lines to the connection pad; and
providing an electrical signal to the connection pad so as to actuate one or more of the MEMS elements.

16. The method of claim 15, further comprising providing an electrical signal to the switches so as to configure the switches to electrically disconnect the plurality of addressing lines to the connection pad.

17. The method of claim 15, further comprising analyzing a response of the MEMS elements so as to determine whether the MEMS elements are operating according to an expected response.

18. The method of claim 17, wherein the response comprises an optical response.

19. A method of operating a MEMS (Microelectromechanical system) device comprising an array of MEMS elements, wherein the array comprises a plurality of addressing lines, a connection pad, and a plurality of switches configured to selectively connect the plurality of addressing lines to the connection pad, the method comprising:
providing an electrical signal to the switches so as to configure the switches to electrically disconnect the plurality of addressing lines from the connection pad; and
providing one or more electrical signals to the plurality of addressing lines so as to operate the MEMS elements.

20. The method of claim 19, wherein the array is configured to display an image in response to the electrical signals.

21. A MEMS (Michroelectromechanical system) device comprising:
an array of MEMS elements, the array comprising a plurality of addressing lines;
a connection pad; and
means for selectively connecting two or more of the addressing lines to the connection pad.

22. The device of claim 21, wherein the array comprises means for interferometrically modulating light.

23. The device of claim 21, comprising four connection pads, and the array comprising:
first and second sets of non-adjacent rows;
first and second sets of non-adjacent columns;
a first group of addressing lines connected to the first set of non-adjacent rows;
a second group of addressing lines connected to the second set of non-adjacent rows;
a third group of addressing lines connected to the first set of non-adjacent columns;
a fourth group of addressing lines connected to the second set of non-adjacent columns,
wherein the connecting means is configured to selectively connect each of the first, second, third, and fourth group of addressing lines to one of the four connection pads.
